(19) United States
(12) Patent Application Publication
(10) Pub. No.: US 2026/0333456 A1
(43) Pub. Date: Oct. 22, 2026

(54) CONFIGURING TIME DOMAIN OFFSETS BETWEEN PAGING SIGNALING AND RANDOM ACCESS CHANNEL SIGNALING

(71) Applicant: Lenovo (United States) Inc., Morrisville, NC (US)

(72) Inventors: Karthikeyan Ganesan, Nauheim (DE); Ravi Kuchibhotla, Chicago, IL (US)

(73) Assignee: Lenovo (United States) Inc., Morrisville, NC (US)

(21) Appl. No.: 19/442,754

(22) Filed: Jan. 7, 2026

(51) Int. Cl. H04W 74/0833; H04W 52/02; H04W 68/02; H04W 72/0446

(52) U.S. Cl. CPC H04W 74/0833; H04W 52/0235; H04W 68/02; H04W 72/0446

(57) ABSTRACT

Various aspects of the present disclosure relate to configuring time domain offsets between paging signaling and random access channel (RACH) signaling. A user equipment (UE) may receive configuration signaling from a network equipment (NE) that indicates a set of time domain offsets between paging signaling and RACH signaling. The set of time domain offsets are associated with respective capabilities corresponding to the UE, where the capabilities may be based on a device type of the UE. The UE may receive the paging signaling from the NE. The UE and the NE may select a time domain offset of the set of time domain offsets based on a capability of the respective capabilities corresponding to the UE. The UE may transmit the RACH signaling to the NE based on the selected time domain offset.

### TECHNICAL FIELD

The present disclosure relates to wireless communications, and more specifically to selecting resources for the wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive information that indicates a set of time domain offsets (e.g., delays, durations) between paging signaling and a set of random access channel (RACH) occasions associated with RACH signaling, where the set of time domain offsets are based on a set of UE capabilities (e.g., capabilities based on device types, among other capabilities), select a time domain offset of the set of time domain offsets based on a UE capability of the set of UE capabilities corresponding to the UE, where the time domain offset is between the paging signaling and a RACH occasion of the set of RACH occasions, and transmit, based on the time domain offset, the RACH signaling during the RACH occasion.

A processor (e.g., a standalone processor chipset, or a component of a UE) for wireless communication is described. The processor may be configured to, capable of, or operable to perform one or more operations as described herein. For example, the processor may be configured to, capable of, or operable to receive information that indicates a set of time domain offsets between paging signaling and a set of RACH occasions associated with RACH signaling, where the set of time domain offsets are based on a set of UE capabilities corresponding to a UE, select a time domain offset of the set of time domain offsets based on a UE capability of the set of UE capabilities corresponding to the UE, where the time domain offset is between the paging signaling and a RACH occasion of the set of RACH occasions, and transmit, based on the time domain offset, the RACH signaling during the RACH occasion.

A method performed or performable by a UE for wireless communication is described. The method may include receiving information that indicates a set of time domain offsets between paging signaling and a set of RACH occasions associated with RACH signaling, where the set of time domain offsets are based on a set of UE capabilities corresponding to the UE, selecting a time domain offset of the set of time domain offsets based on a UE capability of the set of UE capabilities corresponding to the UE, where the time domain offset is between the paging signaling and a RACH occasion of the set of RACH occasions, and transmitting, based on the time domain offset, the RACH signaling during the RACH occasion.

In some implementations of the UE, the processor, and the method described herein, to transmit the RACH signaling, the UE, the processor, and the method may further be configured to, capable of, or operable to receive the paging signaling, and select the RACH occasion based on the paging signaling and the time domain offset. In some implementations, the UE, the processor, and the method may be configured to, capable of, or operable to monitor for the paging signaling using at least one of a low power state or a low power radio, where the time domain offset includes an additional time domain offset associated with switching from the low power state or the low power radio to transmit the RACH signaling. In some implementations, the UE, the processor, and the method may be configured to, capable of, or operable to monitor for the paging signaling using at least one of a low power state or a low power radio, and refrain from applying, based on the time domain offset, an additional time domain offset associated with switching from the low power state or the low power radio to transmit the RACH signaling.

In some implementations, the UE capability is based on at least one of a device type of the UE or an operation mode of the UE. In some implementations, the information is received in a system information block (SIB), at least one parameter associated with the SIB indicates at least one of the set of time domain offsets or a set of back-off indicator (BI) values associated with the set of UE capabilities, and the UE, the processor, and the method may be configured to, capable of, or operable to select, based on a failure to receive a response to the RACH signaling, a BI value of the set of BI values, where the BI value is associated with the UE capability, and transmit, after expiry of the BI value, additional RACH signaling during an additional RACH occasion. In some implementations, to receive the information, the UE, the processor, and the method may be configured to, capable of, or operable to receive the paging signaling including at least one field that indicates the information. In some implementations, the information is received in a synchronization signal block (SSB) associated with a periodicity, and the paging signaling and the SSB are within a threshold duration based on the periodicity and based on an active transmission duration associated with an NE. In some implementations, the information includes a mapping between one or more paging occasions associated with the paging signaling and one or more RACH occasions associated with the RACH signaling, and the time domain offset is based on the mapping. In some implementations, the UE, the processor, and the method may further be configured to, capable of, or operable to transmit a wake-up signal that indicates a public land mobile network (PLMN), where the information is received in response to the wake-up signal and from an NE associated with the PLMN.

An NE (e.g., a base station) for wireless communication is described. The NE may be configured to, capable of, or operable to perform one or more operations as described herein. For example, the NE may be configured to, capable of, or operable to transmit information that indicates a set of time domain offsets (e.g., delays, durations) between paging signaling and a set of RACH occasions associated with RACH signaling, where the set of time domain offsets are based on a set of UE capabilities corresponding to one or more UEs (e.g., capabilities based on device types of the UEs, among other capabilities), select a time domain offset of the set of time domain offsets based on a UE capability of the set of UE capabilities, where the UE capability corresponds to a UE of the one or more UEs, and where the time domain offset is between the paging signaling and a RACH occasion of the set of RACH occasions, and receive, based on the time domain offset, the RACH signaling during the RACH occasion.

A processor (e.g., a standalone processor chipset, or a component of an NE) for wireless communication is described. The processor may be configured to, capable of, or operable to perform one or more operations as described herein. For example, the processor may be configured to, capable of, or operable to transmit information that indicates a set of time domain offsets between paging signaling and a set of RACH occasions associated with RACH signaling, where the set of time domain offsets are based on a set of UE capabilities corresponding to one or more UEs, select a time domain offset of the set of time domain offsets based on a UE capability of the set of UE capabilities, where the UE capability corresponds to a UE of the one or more UEs, and where the time domain offset is between the paging signaling and a RACH occasion of the set of RACH occasions, and receive, based on the time domain offset, the RACH signaling during the RACH occasion.

A method performed or performable by an NE (e.g., a base station) for wireless communication is described. The method may include transmitting information that indicates a set of time domain offsets between paging signaling and a set of RACH occasions associated with RACH signaling, where the set of time domain offsets are based on a set of UE capabilities corresponding to one or more UEs, selecting a time domain offset of the set of time domain offsets based on a UE capability of the set of UE capabilities, where the UE capability corresponds to a UE of the one or more UEs, and where the time domain offset is between the paging signaling and a RACH occasion of the set of RACH occasions, and receiving, based on the time domain offset, the RACH signaling during the RACH occasion.

In some implementations of the NE, the processor, and the method described herein, to receive the RACH signaling, the NE, the processor, and the method may further be configured to, capable of, or operable to transmit the paging signaling, and select the RACH occasion based on the paging signaling and the time domain offset. In some implementations, the UE capability is based on at least one of a device type of the UE or an operation mode of the UE. In some implementations, the information is received in a SIB, and at least one parameter associated with the SIB indicates at least one of the set of time domain offsets or a set of BI values associated with the set of UE capabilities. In some implementations, to transmit the information, the NE, the processor, and the method may further be configured to, capable of, or operable to transmit the paging signaling including at least one field that indicates the information. In some implementations, the information is received in an SSB associated with a periodicity, and the paging signaling and the SSB are within a threshold duration based on the periodicity and based on an active transmission duration associated with the NE. In some implementations, the information includes a mapping between one or more paging occasions associated with the paging signaling and one or more RACH occasions associated with the RACH signaling, and the time domain offset is based on the mapping. In some implementations, the NE, the processor, and the method may further be configured to, capable of, or operable to receive a wake-up signal that indicates a PLMN, where the information is transmitted in response to the wake-up signal and based on the PLMN being associated with the NE.

### BRIEF DESCRIPTION OF THE DRAWINGS

FIG. 1 illustrates an example of a wireless communications system in accordance with aspects of the present disclosure.

FIGS. 2 through 4 illustrate examples of transmission diagrams, in accordance with aspects of the present disclosure.

FIG. 5 illustrates an example of a signaling diagram, in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

### DETAILED DESCRIPTION

In a wireless communications system, a UE and an NE (e.g., a base station, a gNB) may support transmission and reception of signaling, referred to as wireless communication. For example, the NE may transmit one or more paging messages to notify a UE that there is incoming data or signaling intended for the UE, prompting the UE to initiate a connection with the NE. In some cases, upon receiving a paging message, the UE may perform a RACH procedure to establish or reestablish a connection with the NE. In the RACH procedure, the UE transmits a random access preamble on designated (e.g., scheduled, allocated) RACH resources to request access to the NE. The NE may implement power saving mechanisms, including bundling or clustering signaling (e.g., the paging messages and signaling related to the RACH procedure) in a time domain to provide for the NE to enter a sleep mode or state in between signaling. However, paging frames (PFs) that include the paging messages and RACH resources may be clustered close to each other, and multiple UE devices of different types and/or capabilities may be paged at a same time, leading to increased RACH collisions. For example, UEs that are paged using a compact clustered structure may select a same earliest RACH resource occasion for transmission of a preamble of the RACH procedure. Additionally, or alternatively, different device types, such as mobile broadband (MBB) devices and Internet-of-Things (IoT) devices, may have different latency criterion and delay tolerances. Without mechanisms to differentiate RACH resource selection according to device capabilities and types, the clustering of paging and RACH resources may lead to congestion and collisions, such as if a relatively large numerical quantity (e.g., number, amount) of IoT devices attempt random access simultaneously with other device types.

As described herein, to reduce RACH collisions and improve resource allocation, an NE may transmit information (e.g., in a SIB in radio resource control (RRC) signaling, a medium access control-control element (MAC-CE), downlink control information (DCI), in paging signaling, or other control signaling) to a UE that indicates time domain offsets between paging signaling and RACH occasions allocated for RACH signaling. The time domain offsets may be mapped to respective capabilities of one or more UEs (e.g., UE capabilities), where the capabilities may be determined by device types, such as MBB devices or IoT devices, or operation modes of the UEs. The NE may transmit paging signaling to the UE, and the UE may select a time domain offset from the set of time domain offsets that matches a capability of the UE. For example, the UE may select a time domain offset that satisfies (e.g., meets, is sufficient for) a latency criterion of the device type or capabilities of the UE, such as a relatively short time domain offset (e.g., less than a threshold value) if the UE is an MBB device or a relatively long time domain offset (e.g., greater than a threshold value) if the UE is IoT device, among other examples. The UE transmits the RACH signaling according to the selected time domain offset, where the time domain offset represents a delay or wait time between receiving the paging signaling and transmitting the RACH signaling in a RACH occasion.

By performing the described techniques, a device (e.g., a UE and/or an NE) in a wireless communications system may provide for improved resource allocation, reduced RACH collisions, and enhanced network efficiency during paging and random access procedures. For example, an NE may configure a UE with time domain offsets between paging signaling and RACH signaling that are differentiated according to device types or capabilities, enabling different UEs to select different RACH occasions according to respective latency and access delay criterion. For example, a device type with lower latency criterion (e.g., an MBB device) may apply a shorter time domain offset to access an earlier RACH occasion, while a device type with higher delay tolerance (e.g., an IoT device) may apply a longer time domain offset to access a later RACH occasion. The differentiation may reduce congestion and collisions by distributing RACH transmissions across multiple RACH occasions, rather than concentrating transmissions at a same earliest RACH occasion following paging. Additionally, or alternatively, the NE may support network energy saving by clustering paging and RACH resources in the time domain. The clustering may reduce or mitigate collisions for random access procedures performed by different device types, while enabling the NE to enter sleep modes for longer durations between active transmission periods.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

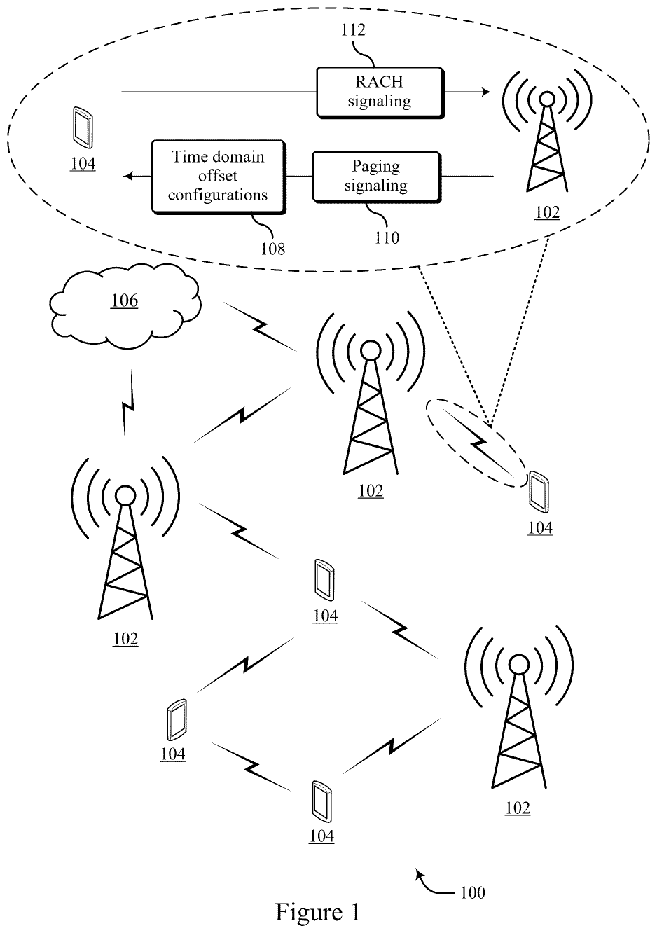

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an IoT device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexed (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the wireless communications system 100, energy consumption by a RAN, including the NEs 102, referred to as network energy consumption, may impact overall efficiency of the wireless communications system 100 and may impact environmental sustainability, including greenhouse gas emissions. Fifth generation (5G) New Radio (NR) may offer energy-efficiency improvements per gigabyte over previous generations of mobile communications. However, new 5G use cases and the adoption of millimeter wave (mmWave) frequencies may utilize an increased numerical quantity (e.g., number, amount) of sites and antennas, which may lead to increased energy consumption. As 5G becomes more pervasive across industries and geographical areas, handling more advanced services and applications that may utilize high data rates (e.g., extended reality (XR) applications or other applications that utilize greater than a threshold data rate), networks may become denser and may use more antennas, larger bandwidths, and more frequency bands. In some examples, active antenna units (AAUs) at the NEs 102 (e.g., antenna units that are actively transmitting and/or receiving) may contribute to a majority (e.g., greater than a threshold amount) of the energy consumption in the wireless communications system 100, with data centers and fiber transport accounting for a smaller portion of the energy consumption in the wireless communications system 100.

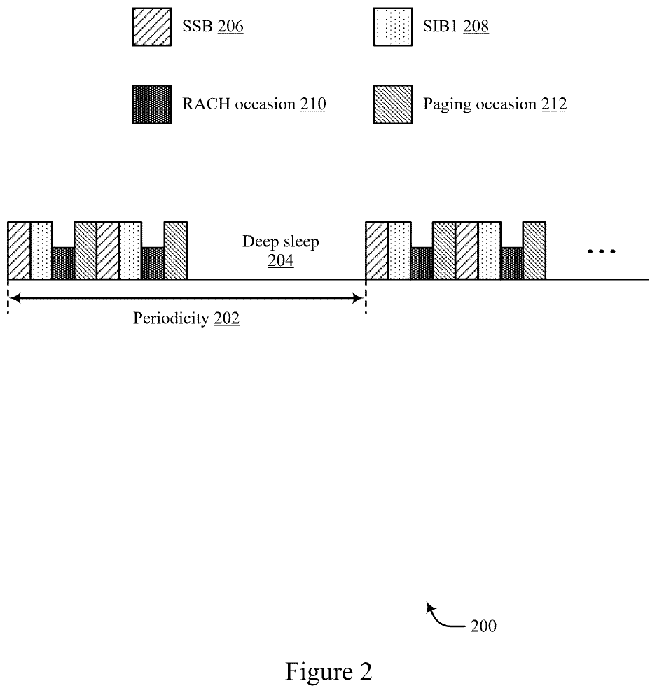

The power consumption of the RAN may include a dynamic portion that the RAN may consume when data transmission or reception is ongoing, and a static portion that the RAN may consume to maintain operation of radio access devices when data transmission or reception is not ongoing. As wireless communications systems evolve to support higher data rates, denser network deployments, and additional frequency bands, the NEs 102 and UEs 104 may implement network energy saving techniques to address increased energy demands, while maintaining network performance. The NEs 102 and UEs 104 may implement network energy saving techniques in time, frequency, spatial, and power domains, with support or feedback from UEs, UE assistance information, and information exchange or coordination over network interfaces. For example, an NE 102 may cluster signaling, such as SSBs, SIBs, paging occasions, and RACH occasions, in the time domain to enable the NE 102 to enter a sleep mode or low power state for longer durations between active transmission periods, as described in further detail with respect to FIG. 2. The clustering of signaling may involve grouping cell-common channels and signals together within defined time periods, followed by deep sleep periods during which the NE 102 operates in a low power state and may deactivate or suspend one or more functional components, including transmission and reception circuitry, to conserve energy.

A UE 104 may operate in an inactive mode or an idle mode to reduce power consumption at the UE 104. In the inactive mode, the UE 104 may maintain an RRC connection with the NE 102, which may provide for faster transition to an active or connected state for data transmission or reception. For example, in the inactive mode, the UE 104 may retain one or more configuration parameters, such as security keys and UE context information, at both the UE 104 and the NE 102, which may reduce signaling overhead when resuming communications. Transitioning from the inactive mode to an active or connected state may involve reestablishing an existing RRC connection. The inactive mode may be referred to as RRC inactive mode or RRC_INACTIVE state. In the idle mode, the UE 104 may not maintain an RRC connection with the NE 102, and the UE context may not be stored at the RAN. The idle mode may be referred to as RRC idle mode or RRC IDLE state. In the idle mode, the UE 104 may perform cell selection and reselection procedures to camp on a cell. Transitioning from the idle mode to an active or connected state may involve establishing a new RRC connection, which may include additional signaling compared to resuming from the inactive mode.

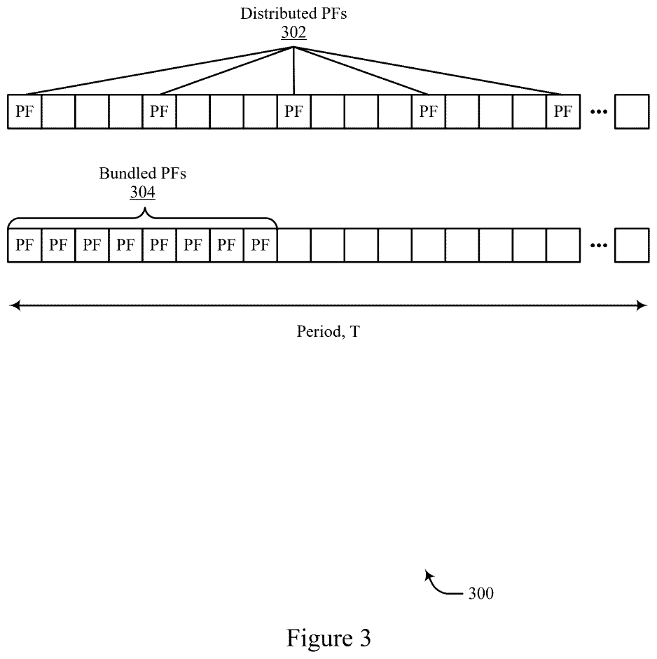

An NE 102 may support paging procedures to notify one or more UEs 104 of incoming data and/or control signaling. In both the inactive mode and the idle mode, the UE 104 may monitor for paging messages from the NE 102 according to a discontinuous reception (DRX) cycle to determine whether incoming data and/or control signaling is available for the UE 104. The DRX cycle may define when the UE 104 wakes up from a low power state to monitor for paging, and the UE 104 may return to the low power state between paging occasions to conserve battery power. The paging DRX cycle in the idle mode may be configured differently than the paging DRX cycle in the inactive mode, and the NE 102 may configure different DRX cycle lengths based on UE capabilities or service criterion. The NE 102 may transmit a paging message to prompt a UE 104 to initiate a new connection or reestablish a connection with the NE 102. The NE 102 may transmit paging messages during paging occasions, which may occur within PFs. A PF may refer to a radio frame during which the NE 102 configures paging occasions. A paging occasion may refer to a time instance or resource during which a UE 104 monitors for paging messages. In some cases, PFs may be distributed across time, with PFs spaced apart from one another at regular intervals throughout a time period. In some other cases, PFs may be bundled or clustered together consecutively at specific time periods rather than being distributed throughout, which may provide for the NE 102 to enter sleep mode for longer durations during extended periods when no PFs are scheduled, which is described in further detail with respect to FIG. 3.

In some cases, upon receiving a paging message, a UE 104 may perform a RACH procedure to establish or reestablish a connection with an NE 102. The RACH procedure may be a four-step RACH procedure or a two-step RACH procedure. In a four-step RACH procedure, the UE 104 may transmit a first message (Msg1) that includes a random access preamble to the NE 102. The NE 102 may respond with a second message (Msg2) that includes a random access response (RAR), which may include timing advance information, an uplink grant, and/or a temporary identifier. The UE 104 may then transmit a third message (Msg3) that includes an RRC connection request or other control signaling using the uplink grant provided in the RAR. The NE 102 may complete the procedure by transmitting a fourth message (Msg4) that includes contention resolution information to resolve any collisions that may have occurred when multiple UEs transmitted preambles on the same RACH occasion. In a two-step RACH procedure, the UE 104 may transmit a first message (MsgA) that combines the preamble and the payload (e.g., the content that would be transmitted in Msg3 of the four-step procedure) in a single transmission. The NE 102 may respond with a second message (MsgB) that combines the RAR and contention resolution information. The two-step RACH procedure may reduce latency compared to the four-step RACH procedure by reducing the number of message exchanges between the UE 104 and the NE 102.

In some examples, the UE 104 transmitting a random access preamble of the RACH procedure on one or more designated (e.g., scheduled, allocated, configured, indicated) RACH resources, which may be referred to as RACH occasions. A RACH occasion may be an example of a time and frequency resource that the NE 102 allocates for transmission of random access preambles. The NE 102 may respond to the random access preamble with an RAR. The RACH procedure may be contention-based random access (CBRA), where multiple UEs 104 may select from a pool of preambles and the NE 102 may perform contention resolution, or contention-free random access (CFRA), where the NE 102 may assign a dedicated preamble to a UE 104. In CBRA, if the RAR is not received by a UE 104 or if a Msg3 of the RACH procedure fails (e.g., no contention resolution), then the UE 104 may set a timer by selecting a random BI within a back-off interval and may select a subsequent RACH resource after the back-off period expires. The BI may define a range from which the UE 104 randomly selects a wait time before attempting a subsequent RACH transmission.

In some examples, an NE 102 may transmit SSBs to provide synchronization and cell identification information to UEs 104. An SSB may include a primary synchronization signal (PSS), a secondary synchronization signal (SSS), and a physical broadcast channel (PBCH). The NE 102 may transmit SSBs according to an SSB periodicity, which may define the time interval between SSB transmissions. The NE 102 may configure a mapping between SSBs and RACH occasions, which may be referred to as SSB-RO mapping. The SSB-RO mapping may indicate which RACH occasions are associated with which SSBs, which the UE 104 may use for beam indication purposes. In some cases, the NE 102 may define an SSB to RACH association period, which may specify a time duration during which at least one RACH resource is allocated to an SSB within one association. The NE 102 may configure multiple SSB to RACH association periods for different device types, such that at least one RACH resource is allocated to an SSB within one association for each device type.

In some cases, an NE 102 may implement network energy saving mechanisms, including clustering or bundling of cell-common signaling in the time domain. Cell-common signaling may include synchronization signals, broadcast physical downlink control channel (PDCCH), SIBs (e.g., SIB1), paging, and/or RACH resources. Clustered provisioning of cell-common signaling may involve the NE 102 grouping the signals and channels together in the time domain, which may provide for the NE 102 to enter a sleep mode or low power state for longer durations between active transmission periods. On-demand provisioning of cell-common signaling may involve the NE 102 transmitting one or more signals or channels in response to a request from a UE 104, such as a wake-up signal. In some examples, the clustered PFs may be transmitted closer to the SSBs due to finer time-synchronization criterion for decoding the paging message and within the cell active transmission period. The paging may be adapted according to the SSB periodicity, and a paging formula may include the SSB periodicity as a parameter, as well as a number of clustered PFs and paging occasions closer to one or more clustered SSBs within a period to calculate the PFs and paging occasions.

In some examples, a UE 104 may support low power operation modes, including monitoring for paging using a low power state or a low power radio. A low power wake-up radio (LPWUR) may be a receiver that operates with reduced power consumption compared to a main radio and that the UE 104 may use to monitor for wake-up signals or early paging indicators. A low power wake-up signal may be a signal that an NE 102 transmits and that an LPWUR may detect to trigger the UE 104 to activate a main radio. An early paging indicator (PEI) may be a signal that indicates to a UE 104 whether paging is expected in an upcoming paging occasion, which may provide for the UE 104 to remain in a low power state if no paging is expected. A wake-up delay may refer to a time duration for a UE 104 to transition from a low power state to an active state, which may include the UE 104 ramping up radio frequency (RF) components or switching from a low power radio to a main radio.

In some cases, if an NE 102 bundles or clusters PFs in the time domain to provide for the NE 102 to enter sleep mode for longer durations, then the NE 102 may reduce a numerical quantity (e.g., amount, number) of SSBs for the bundled PFs. With fewer SSBs, there may be fewer SSB-RO mapping occasions, which may increase RACH collisions when the paging load remains unchanged. That is, UEs 104 that receive paging using a compact clustered structure may select a same earliest RACH occasion for transmission, which may result in collisions. Additionally, or alternatively, the wireless communications system 100 may support diverse device types, and different device types may have different latency and delay criterion. For example, MBB devices may have lower latency criterion (e.g., shorter acceptable delay for data transmission, faster response time criterion for interactive applications) compared to IoT devices, which may have higher delay tolerance (e.g., longer acceptable wait times before transmitting data, relaxed timing criterion for sensor reporting). In some cases, MBB devices may support applications (e.g., video streaming, voice calls, or web browsing) that may benefit from reduced access delays. In some cases, IoT devices may support applications (e.g., periodic sensor measurements, environmental monitoring, or asset tracking) that may tolerate longer access delays without impacting application performance. In 6G radio access technology, diverse device types are supported, and massive quantities of low tier IoT device types may create congestion to the RACH access if the devices attempt random access simultaneously with other device types. Without mechanisms to differentiate RACH resource selection according to device capabilities and types, the clustering of paging and RACH resources may lead to congestion and collisions.

According to implementations, one or more of the NEs 102 and the UEs 104 are operable to implement various aspects of the techniques described with reference to the present disclosure. For example, a UE 104 receives information from an NE 102 that indicates multiple time domain offset configurations 108. In some cases, the time domain offset configurations 108 include multiple paging-to-RACH delays between paging signaling 110 and RACH occasions allocated for RACH signaling 112. The NE 102 maps the time domain offset configurations 108 to respective capabilities of one or more UEs 104 (e.g., UE capabilities), where the NE 102 or the UE 104 determines the capabilities based on device types (e.g., MBB devices, IoT devices) and/or operation modes of the UEs 104 (e.g., low power operation mode, active operation mode, or connected operation mode). For example, the mapping may associate each time domain offset configuration with a corresponding device type or operation mode, such that a UE 104 may identify which time domain offset value applies based on the device type or operation mode of the UE 104. In some examples, the operation modes may correspond to different power consumption states or different radio configurations at the UE 104. For example, a UE 104 operating in a low power operation mode may monitor for paging using an LPWUR, while a UE 104 operating in an active operation mode may use a main radio for monitoring and transmission. In some examples, the operation mode may indicate whether the UE 104 is configured to use a low power state for paging monitoring or whether the UE 104 maintains full radio functionality during paging occasions.

In some examples, the time domain offset configurations 108 include an integer value describing the delay in ms or a number of slots, which are units in the time domain. For some device types with lower access delay (e.g., MBB devices), the NE 102 configures the time domain offset with a zero paging-to-RACH delay or a relatively short delay value (e.g., less than a threshold value). The UE 104 receives the paging signaling 110 from the NE 102, where the paging signaling 110 includes a paging message that the NE 102 transmits during a paging occasion to notify the UE 104 of incoming data and/or control signaling. In some cases, the UE 104 monitors for the paging signaling 110 using a low power state or a low power radio (e.g., an LPWUR), and the time domain offset includes a wake-up delay to provide sufficient time for the UE 104 to ramp up RF components from the low power state or switch from the low power radio to a main radio and the RF components of the main radio. In some other cases, if the UE 104 is configured to monitor a channel or signal in a low power state or processor, the paging-to-RACH delay may not include the wake-up delay, or both the paging-to-RACH delay and the wake-up delay may not be applied together. The UE 104 selects a time domain offset from the time domain offset configurations 108 that matches a capability of the UE 104 (e.g., the device type of the UE 104 and/or an operation mode of the UE 104). The UE 104 transmits the RACH signaling 112 to the NE 102 in a RACH occasion according to the selected time domain offset. The RACH signaling 112 includes a random access preamble that the UE 104 transmits in the RACH occasion, where the time domain offset represents a delay or wait time (e.g., duration) between receiving the paging signaling 110 and transmitting the RACH signaling 112. The paging-to-RACH delay may not directly indicate the RACH occasion periodicity for each device type, but may indicate the additional latency to be incurred at the device side (e.g., wait time in RACH resource selection after receiving the paging message), and the earliest RACH occasions that can be used by the UE 104 to randomly select a RACH resource after the configured delay.

In some cases, the NE 102 configures a mapping between SSBs and RACH occasions (e.g., the SSB-RO mapping) that the NE 102 maintains across device types. In some other cases, the NE 102 provides an explicit SSB-RO beam indication to support beam management during the random access procedure. For example, the NE 102 may configure the SSB-RO mapping via system information (e.g., SIB1), or the NE 102 may provide the explicit SSB-RO beam indication via a DCI, a MAC-CE, or RRC signaling, among other example control signaling. Maintaining consistent SSB-RO mapping rules across device types enables the UEs 104 to identify a beam for a RACH transmission regardless of the device type, which supports coherent beam management when different device types apply different paging-to-RACH delays. The SSB-RO mapping provides a mechanism for the UE 104 to determine which RACH occasion corresponds to an SSB beam after applying the selected time domain offset according to the capability of the UE 104. For example, if an MBB device applies a shorter time domain offset and an IoT device applies a longer time domain offset, then both device types may use a same SSB-RO mapping to identify a beam association for respective RACH transmissions, thereby reducing complexity, while reducing collisions for RACH transmissions.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

FIG. 2 illustrates an example of a transmission diagram 200 in accordance with aspects of the present disclosure. In some examples, the transmission diagram 200 implements or is implemented by aspects of the wireless communications system 100. For example, the transmission diagram 200 may be implemented by one or more UEs and/or NEs, which may be an example of NEs 102 and UEs 104 as described with reference to FIG. 1. The transmission diagram 200 illustrates an example of clustered common channel and signal transmission with deep sleep periods.

In some examples, an NE may cluster or bundle cell-common signaling in the time domain to enable the NE to enter a sleep mode or low power state for longer durations between active transmission periods. In some cases, the common channels and signals may be repeated according to a periodicity 202. The periodicity 202 represents a time interval during which the NE performs transmission and reception of common channels and signals, followed by the deep sleep period 204 during which the NE operates in a low power state. During the deep sleep period 204, the NE may deactivate or suspend one or more functional components, including transmission and reception circuitry, to conserve energy. Within each periodicity 202, the NE may transmit one or more common channels and signals, including SSBs 206, SIBs (e.g., one or more SIB1s 208), RACH occasions 210, and/or paging occasions 212. The periodicity 202 may be configured based on network traffic patterns, UE density, and/or power saving criterion. The common channels and signals are arranged in clusters within the periodicity 202. Each cluster includes a sequence of SSBs 206, SIB1s 208, RACH occasions 210, and paging occasions 212, enabling the NE to group related signaling activities together before entering the deep sleep period 204.

In some examples, the clustered PFs may be transmitted closer to the SSBs 206 due to finer time-synchronization criterion for decoding the paging message and within the cell active transmission period. The paging may be adapted according to the SSB periodicity, and a paging formula may include the SSB periodicity as a parameter, as well as a number of clustered PFs and paging occasions 212 closer to one or more clustered SSBs 206 within a period to calculate the PF and paging occasions. The NE may configure time domain offsets between the paging occasions 212 and the RACH occasions 210 that are differentiated according to device types or capabilities, enabling different UEs to select different RACH occasions 210 according to respective latency and access delay criterion.

FIG. 3 illustrates an example of a transmission diagram 300 in accordance with aspects of the present disclosure. In some examples, the transmission diagram 300 implements or is implemented by aspects of the wireless communications system 100. For example, the transmission diagram 300 may be implemented by one or more UEs and/or NEs, which may be an example of NEs 102 and UEs 104 as described with reference to FIG. 1. The transmission diagram 300 illustrates an example of distributed PFs compared with bundled PFs within a wireless communications system.

In some examples, the transmission diagram 300 includes distributed PFs 302 and bundled PFs 304 in the time domain over a period, T. A PF may refer to a radio frame during which an NE configures paging occasions for transmission of paging messages to one or more UEs. The period, T, may include a time duration over which PFs are distributed or bundled according to a network configuration. In some cases, the distributed PFs 302 may include PFs spaced apart from one another across the period T. For example, each PF in the distributed PFs 302 may be positioned at a different time instance, such that the PFs are spread throughout the period. In some examples, the bundled PFs 304 may include multiple consecutive PFs that are clustered together within the period (e.g., at the beginning of the period), rather than being distributed throughout the period. For example, the bundled PFs 304 may include eight consecutive PF slots grouped together in the time domain, followed by a series of empty slots for a remaining duration of the period. The bundled PFs 304 may provide for an NE to enter sleep mode for longer durations during extended periods when no PFs are scheduled.

In some cases, such as for the bundled PFs 304, the NE may reduce a numerical quantity (e.g., amount, number) of SSBs. If a cell load and/or a paging load remains the same, then RACH collisions may increase due to the fewer SSBs, which results in fewer SSB-RO mapping occasions. For example, due to the fewer SSB-RO resource mapping with paging load unchanged, the UEs that are paged using the compact structure of the bundled PFs 304 may select a same earliest resource occasion for transmission, resulting in collision. In some examples, to address the increase in RACH collisions resulting from the bundled PFs 304, the NE may configure time domain offsets between paging occasions and RACH occasions that are differentiated according to device types or capabilities, enabling different UEs to select different RACH occasions according to respective latency and access delay criterion.

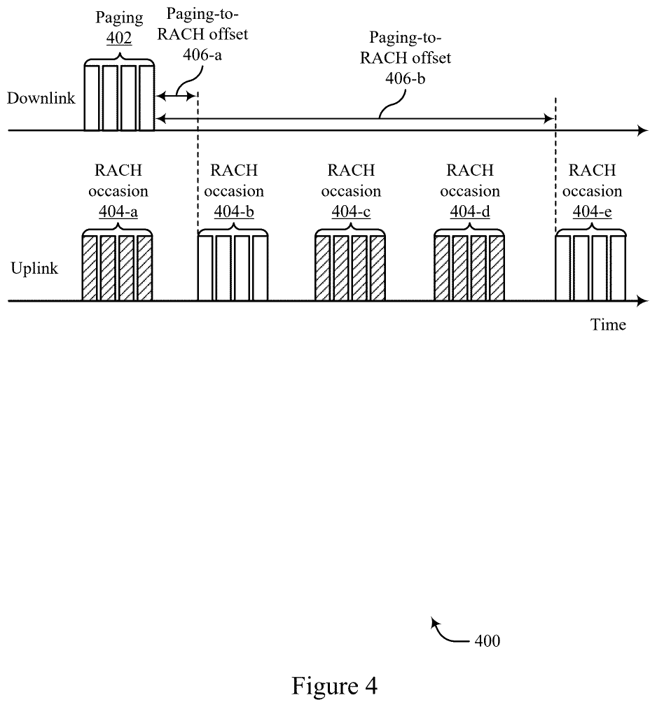

FIG. 4 illustrates an example of a transmission diagram 400 in accordance with aspects of the present disclosure. In some examples, the transmission diagram 400 implements or is implemented by aspects of the wireless communications system 100, the transmission diagram 200, and/or the transmission diagram 300. For example, the transmission diagram 400 may be implemented by one or more UEs and/or NEs, which may be an example of NEs 102 and UEs 104 as described with reference to FIG. 1. The transmission diagram 400 illustrates an example of time domain offsets between paging signaling and RACH occasions for different device types.

In some examples, an NE transmits paging signaling 402 to one or more UEs during a paging occasion. The paging signaling 402 may include a paging message that notifies a UE of incoming data and/or control signaling, as described with reference to FIG. 1. The NE transmits the paging signaling 402 on a downlink channel (e.g., a PDCCH carrying a paging DCI, a physical downlink shared channel (PDSCH) carrying a paging message, or other downlink control or data channel). The paging signaling 402 prompts the UE to initiate a RACH procedure to establish or reestablish a connection with the NE to transmit or receive data and/or control signaling.

In some examples, the transmission diagram 400 includes multiple RACH occasions in the time domain, such as a RACH occasion 404-a, a RACH occasion 404-b, a RACH occasion 404-c, a RACH occasion 404-d, and a RACH occasion 404-e. Although the transmission diagram 400 is illustrated as including five RACH occasions, the transmission diagram 400 may include any numerical quantity of RACH occasions. The NE configures the RACH occasion 404-a through the RACH occasion 404-e on an uplink channel (e.g., a physical RACH (PRACH)). The RACH occasion 404-a through the RACH occasion 404-e include time-frequency resources allocated (e.g., scheduled, indicated, configured) for UEs to transmit random access preambles (e.g., Msg1 in a four-step RACH procedure, or MsgA preamble in a two-step RACH procedure), as described with reference to FIG. 2.

In some examples, the transmission diagram 400 includes a paging-to-RACH offset 406-a that is a first time domain offset between the paging signaling 402 and a RACH occasion, such as the RACH occasion 404-b. The paging-to-RACH offset 406-a may be a shorter time domain offset (e.g., zero ms or slots, a few ms or slots, or a numerical quantity of ms or slots less than a threshold value) configured for device types having lower latency or delay criterion, such as MBB devices (e.g., smartphones, tablets, or other devices supporting voice calls, video streaming, or web browsing). A paging-to-RACH offset 406-b represents a second time domain offset between the paging signaling 402 and later RACH occasions, such as the RACH occasion 404-e. The paging-to-RACH offset 406-b may be a longer time domain offset (e.g., multiple ms or slots or a numerical quantity of ms or slots greater than a threshold value) configured for device types having higher latency or delay criterion, such as IoT devices (e.g., sensors, meters, asset trackers, or other machine-type communication devices). The NE may configure the paging-to-RACH offset 406-a and the paging-to-RACH offset 406-b in ms or a numerical quantity of slots, including an integer numerical quantity of slots and/or ms.

In some examples, the NE may configure multiple paging-to-RACH offsets (e.g., time domain offsets, durations, delays) according to device types. The UE may account for the paging-to-RACH offsets when the UE performs RACH resource selection after receiving the paging signaling 402. For some devices that have a lower access delay criterion (e.g., MBB devices with latency-sensitive applications), the NE may configure a zero paging-to-RACH offset. The NE may configure the paging-to-RACH offset using a SIB (e.g., SIB0 or SIB1). The SIB may include an explicit indication of the paging-to-RACH offset according to the device type for CBRA. A new field in the SIB0 or SIB1 may explicitly indicate the paging-to-RACH offset for each device type. In some cases, the NE may set the paging-to-RACH offset for a low tier IoT device to a first value (e.g., ‘x’ ms, 20 ms or 40 ms) while the NE may set the paging-to-RACH offset for an MBB device to a second value (e.g., ‘y’ ms, 0 ms or 5 ms). In some cases, the first value is greater than the second value (e.g., ‘x’> ‘y’) to avoid RACH collisions in one or more shared RACH resources. In some examples, each device type may use shared RACH resources. The NE may use a same SSB-RACH mapping to indicate a beam. The paging-to-RACH offset configuration describes how each device type may select the shared RACH resources after a configured time domain offset (e.g., delay value, wait time, duration) to avoid congestion.

In some cases, the time domain offset may scale according to a subcarrier spacing (SCS). For example, a configured time domain offset of 10 slots may correspond to approximately 10 ms at a 15 kHz SCS, approximately 5 ms at a 30 kHz SCS, approximately 2.5 ms at a 60 kHz SCS, or approximately 1.25 ms at a 120 kHz SCS, among other examples. In some cases, the NE may configure the time domain offset as a number of slots to provide consistent behavior across different numerologies, or the NE may configure the time domain offset value in ms to provide a fixed time duration regardless of the SCS. In some other cases, a factor describing the paging-to-RACH offset with multiple integer multiplication factors may implement the time domain offset in ms or number of slots for device types. For example, the NE may define a base time domain offset value, and each device type may have a corresponding multiplication factor that scales the time domain offset value to determine the paging-to-RACH offset for that device type. For example, the base time domain offset value may be 5 ms, and an MBB device may be associated with a multiplication factor of 1 (e.g., resulting in a 5 ms time domain offset, delay), while an IoT device may be associated with a multiplication factor of 4 (e.g., resulting in a 20 ms time domain offset, delay), thereby enabling differentiated access timing across device types using a scalable configuration.

In some examples, the NE may introduce multiple tables according to the device types (a first table for MBB devices, a second table for IoT devices, a third table for reduced capability devices, etc.). A UE may select a table according to the number of device types. For example, the configuration signaling may include a set of tables corresponding to different device types, where each table includes multiple rows with multiple time domain offset values, and the SIB may indicate an index to each table. A first table may be associated with MBB devices and include shorter time domain offset values (e.g., 0 ms, 2 ms, 5 ms), while a second table may be associated with IoT devices and include longer time domain offset values (e.g., 10 ms, 20 ms, 50 ms). The UE may identify the device type of the UE and select the corresponding table to determine the applicable paging-to-RACH offset value.

Additionally, or alternatively, the NE may jointly encode table indices for each device type in bits (e.g., a bit field indicating the applicable time domain offset configuration for multiple device types). For example, the NE may use a multi-bit field in the SIB, where a first subset of bits indicates the time domain offset table index for MBB devices and a second subset of bits indicates the time domain offset table index for IoT devices. In some cases, a 6-bit field may allocate 3 bits for each device type to index up to 8 different time domain offset configurations per device type. In some other examples, the NE may encode a joint time domain offset value for each device type using a single index that maps to a predefined set of time domain offset values. For example, an index value of 0 may correspond to time domain offset values of 0 ms for MBB devices and 10 ms for IoT devices, and the index value of 1 may correspond to time domain offset values of 2 ms for MBB devices and 20 ms for IoT devices.

Additionally, or alternatively, the NE may configure a joint time domain offset value for each of the device types. For example, the NE may configure a single paging-to-RACH offset value that applies uniformly across MBB devices, IoT devices, and other device types. In some cases, a joint time domain offset value may be 5 ms, and a UE applies a 5 ms time domain offset value regardless of device type. Configuring a single paging-to-RACH offset value may simplify configuration signaling overhead, while providing a baseline separation between paging signaling and RACH signaling to reduce collisions.

In some cases, the NE configures the paging-to-RACH offset 406-a and the paging-to-RACH offset 406-b via configuration signaling, such as a SIB or other control signaling (e.g., SIB1 transmitted on PDSCH, or SIB0 transmitted on PBCH), as described with reference to FIG. 1. The configuration signaling may include a mapping between device types and/or capabilities (e.g., MBB, IoT, reduced capability, or other device categories) and time domain offsets designated for the device types. A UE selects a time domain offset matching the device type or capability of the UE. For example, a UE that is an MBB device may apply the paging-to-RACH offset 406-a to access the RACH occasion 404-b (e.g., rather than the RACH occasion 404-a and the RACH occasion 404-c through the RACH occasion 404-e). A UE that is an IoT device may apply the paging-to-RACH offset 406-b to access the RACH occasion 404-e (e.g., rather than the RACH occasion 404-a through the RACH occasion 404-d). The differentiation of time domain offsets according to device types distributes RACH transmissions across multiple RACH occasions. The distribution reduces congestion and collisions compared to concentrating transmissions at a same earliest RACH occasion following paging. That is, the paging-to-RACH offset configuration ensures different time domain RACH occasion selection for each device type.

In some cases, the paging-to-RACH offset 406-a and the paging-to-RACH offset 406-b may not directly indicate the RACH occasion periodicity for each device type. The paging-to-RACH offset 406-a and the paging-to-RACH offset 406-b may indicate the additional latency to be incurred at the device side, such as a wait time (e.g., duration, delay, time domain offset) in RACH resource selection after receiving the paging signaling 402. The UE may randomly select a RACH resource from the earliest RACH occasions that the UE can use after the configured time domain offset. For example, the UE may select the RACH occasion 404-b from the RACH occasion 404-a through the RACH occasion 404-e if the configured time domain offset corresponds to the paging-to-RACH offset 406-a. The UE may select from RACH occasion 404-e from the RACH occasion 404-a through the RACH occasion 404-e if the configured time domain offset corresponds to the paging-to-RACH offset 406-b.

In some examples, the NE may configure multiple BI values according to the device type to aid random selection of RACH resources after a first RACH transmission and when a UE does not receive a random access response (RAR) or when Msg3 fails (e.g., no contention resolution). Each UE according to the device type of the UE may set a timer by selecting a random BI within T_{backoff}∈[0, BI] (e.g., upon failure to receive a response to the first RACH transmission, including the RAR or Msg3 failure). The NE may configure a different BI value for each device type to transmit a second RACH (e.g., a shorter BI value, including 0 to 2, for MBB devices, or a longer BI value, including 0 to 10, for IoT devices). In some cases, a low tier IoT UE may transmit a RACH transmission in a shared resource (e.g., on a RACH occasion 404-c or RACH occasion 404-d). If the transmission is not successful, then the IoT UE may select a random back-off from a larger BI value and select a second RACH resource (e.g., RACH occasion 404-e or a subsequent RACH occasion) after the back-off period expires. In some other cases, the paging message or paging DCI (e.g., DCI format 1_0 with CRC scrambled by a paging-radio network temporary identifier (P-RNTI)) may additionally indicate the paging-to-RACH offset. A combination of the above methods is also possible, considering NE initiated and UE initiated traffic. In some examples, the NE may define a set of SSB to RACH association periods considering device types, such that the NE may allocate at least one RACH resource to an SSB within one association.

In some examples, the NE configures a UE to monitor a channel or signal in a low power state or using a low power processor (e.g., an LPWUR or a reduced capability receiver). The UE monitors the paging using the low power state or a low power radio. In some cases, the paging-to-RACH offset may not include the wake-up delay. Additionally, or alternatively, the UE may not apply both the paging-to-RACH offset and the wake-up delay together. The provision of the wake-up delay provides sufficient time for the UE after receiving the paging message to ramp up from the low power state or switch on the main radio and the RF components of the main radio (e.g., power amplifiers, frequency synthesizers, and/or other RF circuitry) to transmit a RACH transmission. In some other cases, the NE may provision the wake-up delay between the PEI or a wake-up signal (e.g., low power wake-up signal) monitoring at the low power state or low power radio and the time to wake up the main radio to monitor the paging message. The UE may also apply the paging-to-RACH offset as the same main radio monitors the paging message and transmits the RACH transmission.

In some examples, an NE may transmit a clustered PF closer to the SSB due to a finer time-synchronization criterion for decoding the paging message and within the cell active transmission period, as described with reference to FIG. 3. The NE may adapt the paging according to the SSB periodicity. A paging formula may include the SSB periodicity as one of the parameters, as well as a numerical quantity (e.g., number, amount) of clustered PFs and paging occasions closer to one or more clustered SSBs within a period to calculate the PF and paging occasions. In some cases, Ns is a numerical quantity of paging occasions in a PF. The parameter iₛ indicates a subframe number (e.g., paging occasion) in the PF. The NE defines (e.g., preconfigures, configures, predefines) the value of iₛ for each value of Ns. The UE may calculate the PF according to Equation 1:

$$PF = SFN mod T = ( \frac{T}{N} ) \times ( {UE}_{ID} mod N ) . \qquad ( 1 )$$

In Equation 1, T is the DRX cycle length in radio frames, N=Min(T, nB), and the parameter nB is a total numerical quantity of paging occasions in one DRX cycle broadcast within SIB1. The parameter, nB, can have values of {4T, 2T, T, T/2, T/4, T/8, T/16, T/32}. The parameter, N, can have values of {T, T/2, T/4, T/8, T/16, T/32}. In some examples, the value of UE_{ID} is based on a temporary mobile subscriber identity (TMSI) and an SSB period, such as UE_{ID}=(TMSI mod 1024) mod SSB period or UE_{ID}=TMSI mod (SSB period). The UE may extract Equation 1 to compute a paging occasion from a look-up table. The UE indexes the look-up table using

$${N}_{s} = Max ( 1 , \frac{nB}{T} ) and {i}_{s} = Floor ( \frac{{UE}_{ID}}{N} ) mod ( Ns ) .$$

In some examples, the NE may define an explicit or implicit mapping between the paging occasion and RACH occasions. An explicit mapping may include configuration signaling from the NE that directly indicates which RACH occasions the NE associates with which paging occasions. An implicit mapping may include a predefined (e.g., defined, configured, preconfigured) association rule between paging occasions and RACH occasions, where the UE may implicitly associate the earliest paging occasion to the earliest RACH occasion, or the NE may define many-to-one or one-to-many associations between paging occasions and RACH occasions based on a pattern or formula. A many-to-one association may refer to a configuration where multiple paging occasions are mapped to a single RACH occasion, such that UEs receiving paging messages in different paging occasions may transmit RACH signaling on a common RACH occasion. A one-to-many association may refer to a configuration where a single paging occasion is mapped to multiple RACH occasions, such that a UE receiving a paging message in that paging occasion may select from among the multiple associated RACH occasions for transmitting RACH signaling. In some examples, the NE may configure the mapping via configuration signaling, such as a SIB, RRC signaling, a MAC-CE, or DCI. Upon receiving the paging signaling 402, the UE may use the mapping to identify which RACH occasion (e.g., RACH occasion 404-a, RACH occasion 404-b, RACH occasion 404-c, RACH occasion 404-d, or RACH occasion 404-e) is associated with the paging occasion in which the UE received the paging signaling 402. For example, a UE with a device type associated with a longer time domain offset (e.g., an IoT device) may select a RACH resource that differs from one or more earliest clustered RACH resources, while a UE with a device type associated with a shorter time domain offset (e.g., an MBB device) may select the earliest available RACH occasion following the paging message, thereby reducing collisions among UEs of different device types.

In some examples, the NE may configure a minimum time gap (e.g., a minimum number of slots or ms, a threshold time gap) between the paging occasion and the RACH occasion. After receiving the paging message, the UE may select the earliest RACH resource after fulfilling the minimum time gap (e.g., the UE may select RACH occasion 404-b if the minimum time gap corresponds to the paging-to-RACH offset 406-a). For example, as illustrated in the transmission diagram 400, if the UE is an MBB device with lower delay or latency criterion, then the mapping may indicate that the UE applies the paging-to-RACH offset 406-a to select RACH occasion 404-b. If the UE is an IoT device with higher delay or latency criterion, then the mapping may indicate that the UE applies the paging-to-RACH offset 406-b to select RACH occasion 404-e. The NE may similarly use the mapping to determine which RACH occasion the UE is to select based on the capability of the UE. The NE may monitor the corresponding RACH occasion (e.g., the RACH occasion 404-b and/or the RACH occasion 404-e) for the RACH signaling from the UE.

In some cases, the NE may define an implicit association rule between the paging occasion and the RACH occasion. The earliest paging occasion may implicitly link to the earliest RACH occasion (e.g., a first paging occasion maps to RACH occasion 404-a, a second paging occasion maps to RACH occasion 404-b). In some other cases, the NE may define many-to-one or one-to-many associations between paging occasions and RACH occasions (e.g., multiple paging occasions may map to a single RACH occasion, or a single paging occasion may map to multiple RACH occasions).

In some examples, the NE provisions an uplink wake-up signal configuration to request on-demand system information or synchronization signals with PLMN information. The PLMN information may include a PLMN identifier, a PLMN code, or other information that identifies a PLMN to which the UE belongs, seeks to connect, or is authorized to access. The UE transmits the uplink wake-up signal that includes PLMN information. The NE configures the uplink wake-up signal to carry the PLMN information as part of the signal payload or as an associated parameter. The NE may use the PLMN information to identify a network affiliation of the requesting UE before responding with system information or synchronization signals. For example, the UE transmits the uplink wake-up signal prior to receiving the paging signaling 402. The NE responds with configuration signaling that includes the time domain offset configurations based on the PLMN association. If a UE sends an uplink wake-up signal information indicating a PLMN (e.g., a PLMN identifier or PLMN code), then the NE verifies whether the uplink wake-up signal matches the PLMN of the NE or one of the PLMNs before transmitting the on-demand system information (e.g., SIB1, other SIBs) or synchronization signals (e.g., SSBs). The NE performs the verification by comparing the received PLMN information against a list of PLMNs that the NE supports or serves. Provisioning the uplink wake-up signal configuration with PLMN information and verifying whether the uplink wake-up signal matches the PLMN before transmitting on-demand system information or synchronization signals reduces power consumption at the NE by preventing the NE from transmitting system information or synchronization signals in response to wake-up signals from UEs associated with different networks.

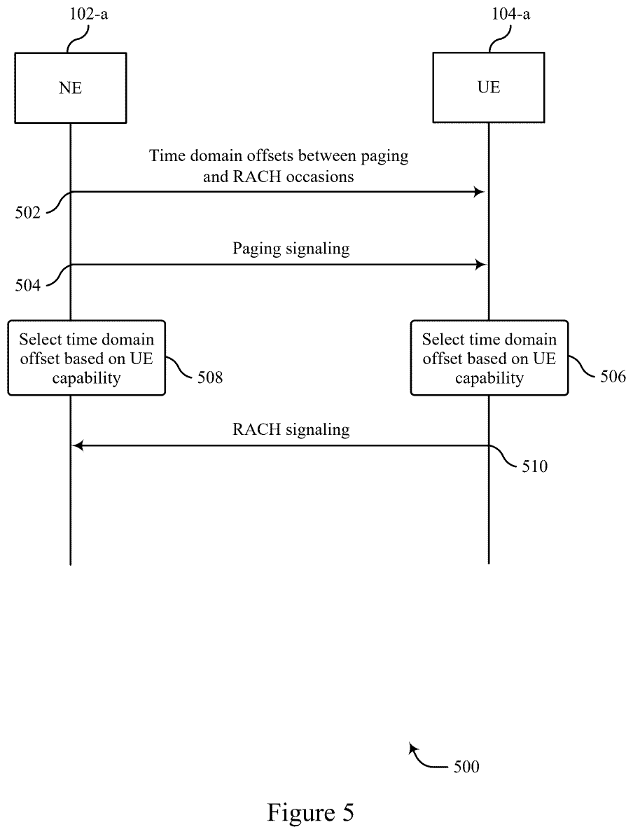

FIG. 5 illustrates an example of a signaling diagram 500 in accordance with aspects of the present disclosure. In some examples, the signaling diagram 500 implements or is implemented by aspects of the wireless communications system 100, the transmission diagram 200, the transmission diagram 300, and the transmission diagram 400. The signaling diagram 500 may implement or be implemented by NE 102-a and UE 104-a, which may be examples of the corresponding devices as described with reference to FIGS. 1 through 4. For example, the NE 102-a may provide the UE 104-a with a configuration for time domain offsets between paging signaling and RACH signaling. Alternative examples of the following may be implemented, where some processes are performed in a different order than described or are not performed. In some cases, processes may include additional features not mentioned below, or further processes may be added.

In some examples, the NE 102-a may be an example of a base station (e.g., gNB) or other network node. The UE 104-a may be an example of an MBB device, an IoT device, or other device type as described with reference to FIG. 1.

At 502, the NE 102-a transmits time domain offsets (e.g., durations, delay values) between paging and RACH occasions to the UE 104-a, which may be referred to as a paging-to-RACH offset or delay. For example, the NE 102-a transmits information (e.g., in configuration signaling, including control signaling and/or paging signaling) that indicates multiple time domain offsets between paging signaling and RACH occasions allocated for RACH signaling. The time domain offsets are associated with (e.g., map to) respective capabilities of the UE 104-a, referred to as UE capabilities. The respective capabilities depend at least in part on a device type of the UE 104-a and/or an operation mode of the UE 104-a. For example, the device type may include an MBB device or an IoT device, where the MBB device may have different latency and delay criterion when compared with the IoT device. In some cases, the device capabilities may include processing capabilities, power consumption characteristics, and/or communication latency criterion (e.g., tolerances) that vary according to the device type. For example, an MBB device, such as a smartphone or tablet, may have capabilities that support low-latency applications, including voice calls, video streaming, or interactive web browsing. An IoT device, such as a sensor or meter, may have capabilities that support longer access delays for periodic data reporting or environmental monitoring applications.

In some examples, the time domain offsets may include an integer value in ms or a numerical quantity (e.g., number, amount) of slots between the paging signaling and a RACH occasion the UE 104-a is to use for RACH signaling. A shorter delay value (e.g., zero or a value less than a threshold) may be configured for device types that support lower access delay criterion, such as MBB devices. A longer delay value (e.g., greater than a threshold) may be configured for device types that support higher access delay criterion, such as IoT devices. In some examples, the configuration signaling includes an SIB (e.g., SIB0 or SIB1), and at least one parameter within the SIB indicates at least one of the time domain offsets or BI values that correspond to the time domain offsets. For example, a new field in the SIB may explicitly indicate different time domain offsets (e.g., paging-to-RACH delays) for each device type. In some examples, the BI values may be configured according to the UE capability for random selection of RACH resources for additional RACH signaling after an initial RACH transmission, such as if an RAR is not received by the UE 104-a or if a Msg3 fails (e.g., no contention resolution, failure to receive a response to the RACH signaling). Each UE may set a timer according to a device type by selecting a random BI within a range from zero to the BI value, and the BI value may be different for each UE capability.

In some examples, the configuration signaling includes an SSB having a periodicity, and the paging signaling and the SSB occur within a threshold duration determined at least in part by the periodicity and by an active transmission duration of the NE 102-a. In some examples, the information includes a mapping between paging occasions allocated for the paging signaling and one or more RACH occasions allocated for the RACH signaling, and the mapping determines the time domain offset. For example, a minimum time gap may be configured between a paging occasion and a RACH occasion. The UE 104-a may receive the paging message and select an earliest RACH resource after fulfilling the minimum time gap. In some examples, an implicit association rule may be defined between paging occasions and RACH occasions. For example, an earliest paging occasion may be implicitly associated to an earliest RACH occasion. In some other examples, a many-to-one or one-to-many association between paging occasions and RACH occasions may be defined. In some examples, multiple SSB to RACH association periods may be defined considering device types, such that at least one RACH resource may be allocated to an SSB within one association for each device type.

In some examples, prior to 502, the UE 104-a transmits a wake-up signal that indicates a PLMN to the NE 102-a. The UE 104-a receives the configuration signaling in response to the wake-up signal from the NE 102-a associated with (e.g., that serves) the PLMN. The NE 102-a receives the wake-up signal that indicates the PLMN, and the NE 102-a transmits the configuration signaling in response to the wake-up signal and based on the PLMN being associated with (e.g., matching) the NE 102-a.

At 504, the NE 102-a transmits paging signaling to the UE 104-a. The paging signaling may include a paging message that notifies the UE 104-a of incoming data or control signaling. In some examples, the paging signaling includes a field that indicates the information (e.g., the time domain offsets). For example, a paging message or paging DCI may include fields with respective values that indicate the time domain offsets, a bitmap that indicates the time domain offsets, tables that indicate the time domain offsets, or any other field that indicates the time domain offsets. In some examples, to receive the paging signaling, the UE 104-a monitors for the paging signaling using at least one of a low power state or a low power radio (e.g., an LPWUR). In some cases, the time domain offset includes an additional time domain offset associated with (e.g., that accounts for) switching from the low power state or the low power radio to transmit the RACH signaling. For example, the additional time domain offset may provide sufficient time for the UE 104-a to ramp up RF components from the low power state or switch from the low power radio to a main radio and the RF components of the main radio.

In some other cases, the UE 104-a refrains from applying an additional time domain offset according to the time domain offset. The additional time domain offset is associated with (e.g., accounts for) switching from the low power state or the low power radio to transmit the RACH signaling. For example, if the UE 104-a is configured to monitor a channel or signal in a low power state or processor, then a paging-to-RACH offset may not include the wake-up delay, or both the paging-to-RACH offset, and the wake-up delay may not be applied together. In some examples, the wake-up delay may be provisioned between a PEI or a wake-up signal monitoring at the low power state or radio and the time to wake up the main radio to monitor the paging message. The paging-to-RACH offset may be additionally applied as the paging message monitoring and RACH transmission are to be transmitted by the same main radio.

At 506, the UE 104-a selects a time domain offset according to the capability of the UE 104-a. For example, the UE 104-a selects a time domain offset based on (e.g., that matches) a capability of the respective capabilities of the UE 104-a. For example, an IoT device and may select a time domain offset value that is relatively long, while an MBB device may select a time domain offset value that is relatively short or zero. The UE 104-a may select a RACH occasion for the RACH signaling according to the time domain offset and the paging signaling. For example, a duration between the paging signaling and the RACH occasion may satisfy (e.g., be greater than or equal to) the time domain offset.

At 508, the NE 102-a selects a time domain offset according to the capability of the UE 104-a. For example, the NE 102-a selects a time domain offset based on (e.g., that matches) a capability of the respective capabilities of the UE 104-a. The NE 102-a may select a RACH occasion for the RACH signaling according to the time domain offset and the paging signaling. For example, a duration between the paging signaling and the RACH occasion may satisfy (e.g., be greater than or equal to) the time domain offset. The selection at both the NE 102-a and the UE 104-a enables coordination for the subsequent RACH transmission. For example, the NE 102-a may determine the expected RACH occasion based on the device type of the UE 104-a and the corresponding time domain offset, which enables the NE 102-a to monitor for the RACH signaling at the appropriate time and resource. In some examples, the UE 104-a may report a UE capability (e.g., a device type or operation mode) to the NE 102-a in capability signaling, such as in uplink control information (UCI) or other control signaling. In some other examples, the NE 102-a may determine the UE capability using a UE identifier or other information (types of signaling received from the UE 104-a, registration information, etc.) available to the NE 102-a.

At 510, the UE 104-a transmits RACH signaling to the NE 102-a during the RACH occasion and according to the selected time domain offset. The time domain offset represents a delay or wait time between receiving the paging signaling and transmitting the RACH signaling, which may vary according to the device type or capability of the UE 104-a to reduce RACH collisions and improve resource allocation. For example, if the time domain offset is relatively short (e.g., zero or less than a threshold value), then the UE 104-a may select an earlier RACH occasion. If the time domain offset is relatively long (e.g., greater than a threshold value), then the UE 104-a may select a later RACH occasion. The NE 102-a receives the RACH signaling according to the time domain offset (e.g., during the RACH occasion). In some cases, if the NE 102-a fails to receive the RACH signaling during the RACH occasion, then the UE 104-a starts a timer that is a duration of a BI value. Upon expiry of the timer (e.g., the BI value), the UE 104-a transmits additional RACH signaling to the NE 102-a. The differentiation of time domain offsets according to device types may reduce congestion and collisions by distributing RACH transmissions across multiple RACH occasions, rather than concentrating transmissions at a same earliest RACH occasion following paging.

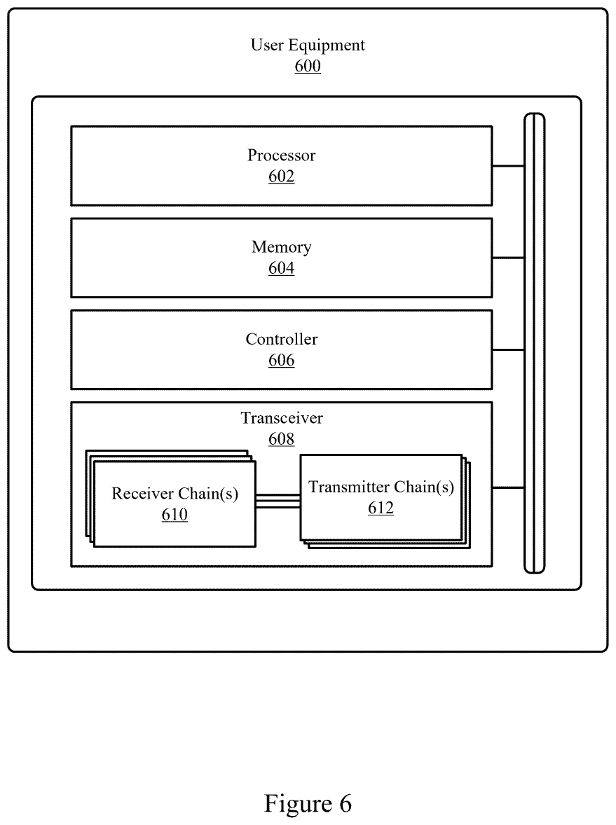

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a central processing unit (CPU), an ASIC, a field-programmable gate-array (FPGA), or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for receiving information that indicates a set of time domain offsets between paging signaling and a set of RACH occasions associated with RACH signaling, where the set of time domain offsets are based on a set of UE capabilities, selecting a time domain offset of the set of time domain offsets based on a UE capability of the set of UE capabilities, where the UE capability corresponds to the UE 600, and where the time domain offset is between the paging signaling and a RACH occasion of the set of RACH occasions, and transmitting, based on the time domain offset, the RACH signaling during the RACH occasion. In this manner, the UE 600 achieves improved resource allocation and reduced RACH collisions by selecting RACH occasions according to device-specific latency and access delay criteria, enabling differentiated access timing for diverse device types.

Additionally, to transmit the RACH signaling, the UE 600 may be configured to or operable to support any one or combination of receiving the paging signaling, and selecting the RACH occasion based on the paging signaling and the time domain offset. This aspect enables precise RACH occasion selection based on configured delays, improving network efficiency by distributing RACH transmissions across multiple occasions rather than concentrating transmissions at a same earliest occasion. Additionally, or alternatively, the UE 600 may be configured to or operable to support monitoring for the paging signaling using at least one of a low power state or a low power radio, where the time domain offset includes an additional time domain offset associated with switching from the low power state or the low power radio to transmit the RACH signaling. This aspect provides sufficient time for the UE 600 to ramp up RF components from the low power state or switch from the low power radio to the main radio, improving power efficiency, while maintaining reliable RACH transmission capability. Additionally, or alternatively, the UE 600 may be configured to or operable to support monitoring for the paging signaling using at least one of a low power state or a low power radio, and refraining from applying, based on the time domain offset, an additional time domain offset associated with switching from the low power state or the low power radio to transmit the RACH signaling. This aspect reduces delays when the paging and RACH are handled by the same processor, improving access latency for devices that do not require additional wake-up time.

Additionally, or alternatively, the UE 600 may be configured to or operable to support the UE capability is based on at least one of a device type of the UE 600 or an operation mode of the UE 600. This aspect enables differentiated RACH resource selection according to device characteristics, providing for MBB devices to access earlier RACH occasions, while delay-tolerant IoT devices access later occasions to reduce congestion. Additionally, or alternatively, the UE 600 may be configured to or operable to support the information is received in an SIB, where at least one parameter associated with the SIB indicates at least one of the set of time domain offsets or a set of BI values associated with the set of UE capabilities, and where the UE 600 may be configured to or operable to support selecting, based on a failure to receive a response to the RACH signaling, a BI value of the set of BI values, where the BI value is associated with the UE capability, and transmitting, after expiry of the BI value, additional RACH signaling during an additional RACH occasion. This aspect enables efficient broadcast configuration of paging-to-RACH delays for multiple device types, reducing signaling overhead, while providing comprehensive delay configuration. Additionally, or alternatively, to receive the information, the UE 600 may be configured to or operable to support receiving the paging signaling including at least one field that indicates the information. This aspect combines paging and configuration information, reducing signaling complexity and enabling dynamic delay configuration based on current network conditions.

Additionally, or alternatively, the UE 600 may be configured to or operable to support the information is received in an SSB associated with a periodicity, and where the paging signaling and the SSB are within a threshold duration based on the periodicity and based on an active transmission duration associated with an NE. This aspect enables clustered provisioning of cell-common signaling, providing for the NE to enter sleep mode for longer durations between active transmission periods to achieve network energy savings. Additionally, or alternatively, the UE 600 may be configured to or operable to support the information includes a mapping between one or more paging occasions associated with the paging signaling and one or more RACH occasions associated with the RACH signaling, and where the time domain offset is based on the mapping. This aspect maintains coherent beam management across device types by providing consistent SSB-RO mapping, enabling the UE to identify beam associations for RACH transmissions regardless of the applied time domain offset. Additionally, or alternatively, the UE 600 may be configured to or operable to support transmitting a wake-up signal that indicates a PLMN, where the information is received in response to the wake-up signal and from an NE associated with the PLMN. This aspect enables on-demand provisioning of information, reducing or preventing excessive wake-up and transmission from the NE and improving network energy efficiency.

Additionally, or alternatively, the UE 600 may support at least one memory (e.g., the memory 604) and at least one processor (e.g., the processor 602) coupled with the at least one memory and configured to or operable to cause the UE to receive information that indicates a set of time domain offsets between paging signaling and a set of RACH occasions associated with RACH signaling, where the set of time domain offsets are based on a set of UE capabilities, select a time domain offset of the set of time domain offsets based on a UE capability of the set of UE capabilities, where the UE capability corresponds to the UE, and where the time domain offset is between the paging signaling and a RACH occasion of the set of RACH occasions, and transmit, based on the time domain offset, the RACH signaling during the RACH occasion.

Additionally, the UE 600 may be configured to support any one or combination of to select a resource associated with the RACH signaling based on the time domain offset. Additionally, or alternatively, to receive the paging signaling, the UE 600 may be configured to or operable to support to monitor for the paging signaling using at least one of a low power state or a low power radio, where the time domain offset includes an additional time domain offset associated with switching from the low power state or the low power radio to transmit the RACH signaling. Additionally, or alternatively, to receive the paging signaling, the UE 600 may be configured to or operable to support to monitor for the paging signaling using at least one of a low power state or a low power radio, and refrain from applying, based on the time domain offset, an additional time domain offset associated with switching from the low power state or the low power radio to transmit the RACH signaling. Additionally, or alternatively, the UE 600 may be configured to or operable to support the respective capabilities are based on at least one of a device type of the UE or an operation mode of the UE.

Additionally, or alternatively, the UE 600 may be configured to or operable to support the information is received in an SIB, and where at least one parameter associated with the SIB indicates at least one of the set of time domain offsets or a set of BI values associated with the set of time domain offsets. Additionally, or alternatively, the UE 600 may be configured to or operable to support the paging signaling includes the information. Additionally, or alternatively, the UE 600 may be configured to or operable to support the information includes an SSB associated with a periodicity, and where the paging signaling and the SSB are within a threshold duration based on the periodicity and an active transmission duration associated with an NE. Additionally, or alternatively, the UE 600 may be configured to or operable to support the information includes a mapping between one or more paging occasions associated with the paging signaling and one or more RACH occasions associated with the RACH signaling, and where the time domain offset is based on the mapping. Additionally, or alternatively, the UE 600 may be configured to or operable to support to transmit a wake-up signal that indicates a PLMN, where the information is received in response to the wake-up signal and from an NE associated with the PLMN.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

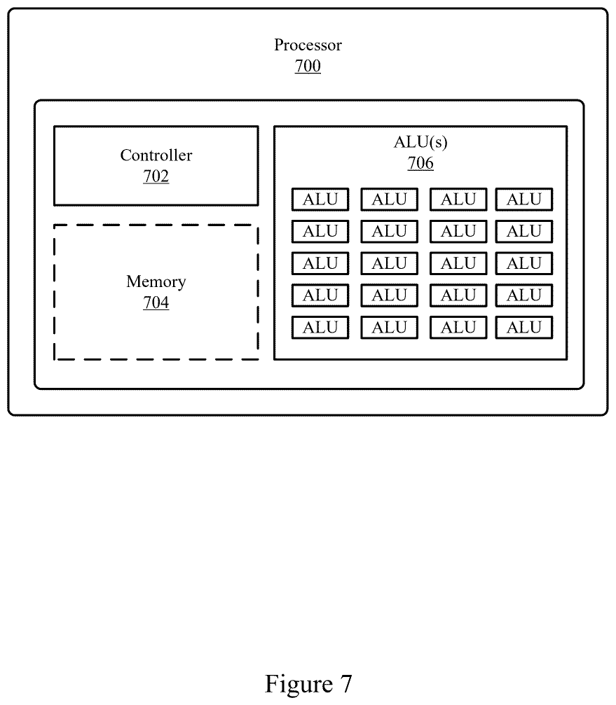

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive information that indicates a set of time domain offsets between paging signaling and a set of RACH occasions associated with RACH signaling, where the set of time domain offsets are based on a set of UE capabilities, select a time domain offset of the set of time domain offsets based on a UE capability of the set of UE capabilities, where the UE capability corresponds to the processor 700, and where the time domain offset is between the paging signaling and a RACH occasion of the set of RACH occasions, and transmit, based on the time domain offset, the RACH signaling during the RACH occasion.

Additionally, to transmit the RACH signaling, the processor 700 may be configured to or operable to support any one or combination of to receive the paging signaling, and select the RACH occasion based on the paging signaling and the time domain offset. This aspect enables precise RACH resource selection based on the configured delay, improving network efficiency by reducing congestion at shared RACH resources. Additionally, or alternatively, the processor 700 may be configured to or operable to support to monitor for the paging signaling using at least one of a low power state or a low power radio, where the time domain offset includes an additional time domain offset associated with switching from the low power state or the low power radio to transmit the RACH signaling. This aspect provides sufficient time for the UE to ramp up RF components from the low power state or switch from the low power radio to the main radio, improving power efficiency, while ensuring reliable RACH transmission. Additionally, or alternatively, the processor 700 may be configured to or operable to support to monitor for the paging signaling using at least one of a low power state or a low power radio, and refrain from applying, based on the time domain offset, an additional time domain offset associated with switching from the low power state or the low power radio to transmit the RACH signaling. This aspect reduces latency for devices that monitor paging and transmit RACH using the same processor, improving access delay performance when wake-up delay is not required. Additionally, or alternatively, the processor 700 may be configured to or operable to support the UE capability is based on at least one of a device type of the processor 700 or an operation mode of the processor 700. This aspect enables differentiated treatment of diverse device types, such as MBB devices and IoT devices, providing for each device type to select RACH occasions according to respective latency and delay tolerance criteria.

Additionally, or alternatively, the processor 700 may be configured to or operable to support the information is received in an SIB, where at least one parameter associated with the SIB indicates at least one of the set of time domain offsets or a set of BI values associated with the set of UE capabilities, and the processor 700 may be configured to or operable to support to select, based on a failure to receive a response to the RACH signaling, a BI value of the set of BI values, where the BI value is associated with the UE capability, and transmit, after expiry of the BI value, additional RACH signaling during an additional RACH occasion. This aspect enables efficient broadcast configuration of paging-to-RACH delays for multiple device types, reducing signaling overhead, while supporting collision avoidance through differentiated back-off intervals. Additionally, or alternatively, to receive the information, the processor 700 may be configured to or operable to support to receive the paging signaling including at least one field that indicates the information. This aspect enables dynamic configuration of time domain offsets within the paging message, improving flexibility for network-initiated traffic scenarios. Additionally, or alternatively, the processor 700 may be configured to or operable to support the information is received in an SSB associated with a periodicity, and where the paging signaling and the SSB are within a threshold duration based on the periodicity and based on an active transmission duration associated with an NE. This aspect supports network energy saving by clustering paging and SSB transmissions within active transmission periods, enabling the NE to enter sleep mode for longer durations between active periods. Additionally, or alternatively, the processor 700 may be configured to or operable to support the information includes a mapping between one or more paging occasions associated with the paging signaling and one or more RACH occasions associated with the RACH signaling, and where the time domain offset is based on the mapping. This aspect enables coherent beam management by maintaining SSB-RO mapping rules across device types, providing for different device types to identify beam associations for respective RACH transmissions, while reducing collisions. Additionally, or alternatively, the processor 700 may be configured to or operable to support to transmit a wake-up signal that indicates a PLMN, where the information is received in response to the wake-up signal and from an NE associated with the PLMN. This aspect enables on-demand provisioning of information, preventing or reducing excessive wake-up and transmission from the NE and improving network energy efficiency.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to transmit information that indicates a set of time domain offsets between paging signaling and RACH signaling, where the set of time domain offsets are associated with respective capabilities corresponding to one or more UEs, select a time domain offset of the set of time domain offsets based on a UE capability of the set of UE capabilities, where the UE capability corresponds to a UE of the one or more UEs, and where the time domain offset is between the paging signaling and a RACH occasion of the set of RACH occasions, and receive, based on the time domain offset, the RACH signaling during the RACH occasion. In this manner, the processor 700 achieves improved resource allocation and enhanced network efficiency by configuring differentiated paging-to-RACH delays for different device types, reducing RACH collisions, while enabling the processor 700 to support network energy saving through clustered signaling.

Additionally, to receive the RACH signaling, the processor 700 may be configured to or operable to support any one or combination of to transmit the paging signaling, and select the RACH occasion based on the paging signaling and the time domain offset. This aspect enables the NE to anticipate RACH resource selection by different device types, improving reception efficiency and resource management. Additionally, or alternatively, the processor 700 may be configured to or operable to support the UE capability is based on at least one of a device type of the UE or an operation mode of the UE. This aspect enables differentiated treatment of diverse device types, such as MBB devices and IoT devices, distributing RACH transmissions across multiple occasions to reduce congestion and collisions. Additionally, or alternatively, the processor 700 may be configured to or operable to support the information is transmitted in an SIB, and where at least one parameter associated with the SIB indicates at least one of the set of time domain offsets or a set of BI values associated with the set of UE capabilities. This aspect enables efficient broadcast configuration of paging-to-RACH delays for multiple device types, reducing signaling overhead, while supporting collision avoidance through differentiated back-off intervals. Additionally, or alternatively, to transmit the information, the processor 700 may be configured to or operable to support to transmit the paging signaling including at least one field that indicates the information. This aspect enables dynamic configuration of time domain offsets within the paging message, improving flexibility for network-initiated traffic scenarios.

Additionally, or alternatively, the processor 700 may be configured to or operable to support the information is transmitted in an SSB associated with a periodicity, and where the paging signaling and the SSB are within a threshold duration based on the periodicity and based on an active transmission duration associated with the processor 700. This aspect supports network energy saving by clustering paging and SSB transmissions within active transmission periods, enabling the processor 700 to enter deep sleep mode for longer durations and reducing power consumption. Additionally, or alternatively, the processor 700 may be configured to or operable to support the information includes a mapping between one or more paging occasions associated with the paging signaling and one or more RACH occasions associated with the RACH signaling, and where the time domain offset is based on the mapping. This aspect enables coherent beam management by maintaining SSB-RO mapping rules across device types, supporting beam indication during random access procedures, while reducing collisions. Additionally, or alternatively, the processor 700 may be configured to or operable to support to receive a wake-up signal that indicates a PLMN, where the information is transmitted in response to the wake-up signal and based on the PLMN being associated with the processor 700. This aspect enables on-demand provisioning of information and prevents or reduces excessive wake-up and transmission from the processor 700 after receiving wake-up signals from UEs not associated with the PLMN, improving network energy efficiency.

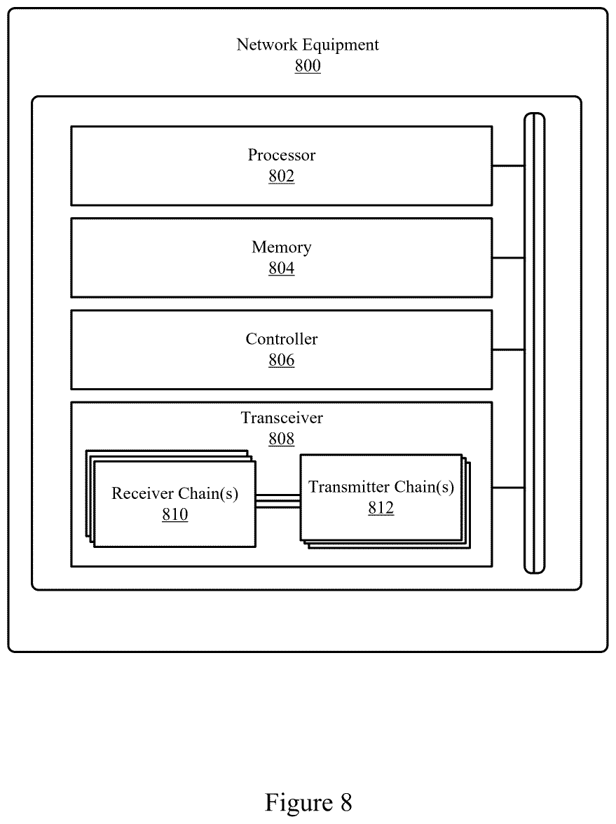

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for transmitting information that indicates a set of time domain offsets between paging signaling and RACH signaling, where the set of time domain offsets are associated with respective capabilities corresponding to one or more UEs, selecting a time domain offset of the set of time domain offsets based on a UE capability of the set of UE capabilities, where the UE capability corresponds to a UE of the one or more UEs, and where the time domain offset is between the paging signaling and a RACH occasion of the set of RACH occasions, and receiving, based on the time domain offset, the RACH signaling during the RACH occasion. In this manner, the NE 800 achieves improved resource allocation and reduced RACH collisions by configuring differentiated paging-to-RACH delays for different device types, enabling the NE 800 to support network energy saving through clustered signaling, while distributing RACH transmissions across multiple RACH occasions.

Additionally, to receive the RACH signaling, the NE 800 may be configured to or operable to support any one or combination of transmitting the paging signaling, and selecting a resource associated with the RACH signaling based on the paging signaling and the time domain offset. This aspect enables the NE 800 to anticipate RACH resource selection by different device types, improving reception efficiency and resource management. Additionally, or alternatively, the NE 800 may be configured to or operable to support the UE capability is based on at least one of a device type of the UE or an operation mode of the UE. This aspect enables differentiated treatment of diverse device types, such as MBB devices and IoT devices, distributing RACH transmissions across multiple occasions to reduce congestion and collisions. Additionally, or alternatively, the NE 800 may be configured to or operable to support the information is transmitted in an SIB, and where at least one parameter associated with the SIB indicates at least one of the set of time domain offsets or a set of BI values associated with the set of UE capabilities. This aspect enables efficient broadcast configuration of paging-to-RACH delays for multiple device types, reducing signaling overhead, while supporting collision avoidance through differentiated back-off intervals. Additionally, or alternatively, to transmit the information, the NE 800 may be configured to or operable to support to transmit the paging signaling including at least one field that indicates the information. This aspect enables dynamic configuration of time domain offsets within the paging message, improving flexibility for network-initiated traffic scenarios.

Additionally, or alternatively, the NE 800 may be configured to or operable to support the information is transmitted in an SSB associated with a periodicity, and where the paging signaling and the SSB are within a threshold duration based on the periodicity and based on an active transmission duration associated with the NE 800. This aspect supports network energy saving by clustering paging and SSB transmissions within active transmission periods, enabling the NE 800 to enter deep sleep mode for longer durations and reducing power consumption. Additionally, or alternatively, the NE 800 may be configured to or operable to support the information includes a mapping between one or more paging occasions associated with the paging signaling and one or more RACH occasions associated with the RACH signaling, and where the time domain offset is based on the mapping. This aspect enables coherent beam management by maintaining SSB-RO mapping rules across device types, supporting beam indication during random access procedures, while reducing collisions. Additionally, or alternatively, the NE 800 may be configured to or operable to support receiving a wake-up signal that indicates a PLMN, where the information is transmitted in response to the wake-up signal and based on the PLMN being associated with the NE 800. This aspect enables on-demand provisioning of information and prevents or reduces excessive wake-up and transmission from the NE 800 after receiving wake-up signals from UEs not associated with the PLMN, improving network energy efficiency.

Additionally, or alternatively, the NE 800 may support at least one memory (e.g., the memory 804) and at least one processor (e.g., the processor 802) coupled with the at least one memory and configured to cause the NE to transmit information that indicates a set of time domain offsets between paging signaling and RACH signaling, where the set of time domain offsets are associated with respective capabilities corresponding to one or more UEs, select a time domain offset of the set of time domain offsets based on a UE capability of the set of UE capabilities, where the UE capability corresponds to a UE of the one or more UEs, and where the time domain offset is between the paging signaling and a RACH occasion of the set of RACH occasions, and receive, based on the time domain offset, the RACH signaling during the RACH occasion.

Additionally, to receive the RACH signaling, the NE 800 may be configured to support any one or combination of to transmit the paging signaling, and select a resource associated with the RACH signaling based on the paging signaling and the time domain offset. Additionally, or alternatively, the NE 800 may be configured to or operable to support the UE capability is based on at least one of a device type of the UE or an operation mode of the UE. Additionally, or alternatively, the NE 800 may be configured to or operable to support the information is transmitted in an SIB, and where at least one parameter associated with the SIB indicates at least one of the set of time domain offsets or a set of BI values associated with the set of UE capabilities. Additionally, or alternatively, to transmit the information, the NE 800 may be configured to or operable to support to transmit the paging signaling including at least one field that indicates the information. Additionally, or alternatively, the NE 800 may be configured to or operable to support the information is transmitted in an SSB associated with a periodicity, and where the paging signaling and the SSB are within a threshold duration based on the periodicity and based on an active transmission duration associated with the NE 800. Additionally, or alternatively, the NE 800 may be configured to or operable to support the information includes a mapping between one or more paging occasions associated with the paging signaling and one or more RACH occasions associated with the RACH signaling, and where the time domain offset is based on the mapping. Additionally, or alternatively, the NE 800 may be configured to or operable to support to receive a wake-up signal that indicates a PLMN, where the information is transmitted in response to the wake-up signal and based on the PLMN being associated with the NE.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., an LNA) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

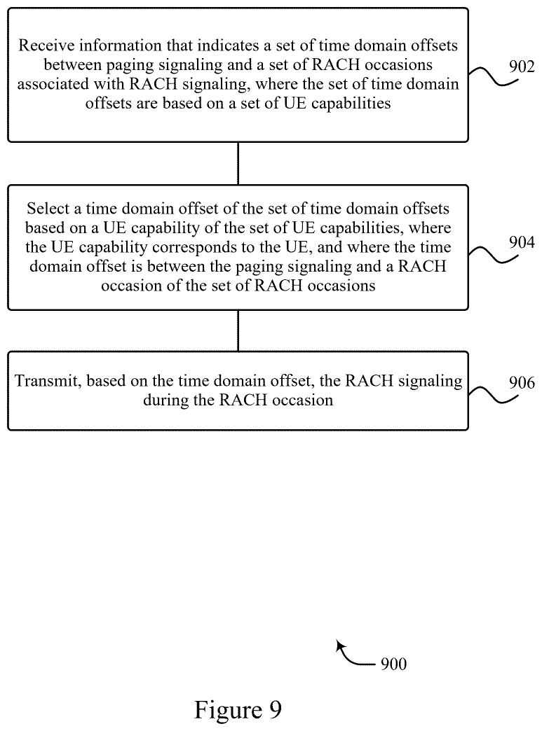

FIG. 9 illustrates a flowchart of a method 900 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 902, the method may include receiving information that indicates a set of time domain offsets between paging signaling and a set of RACH occasions associated with RACH signaling, where the set of time domain offsets are based on a set of UE capabilities. The operations of 902 may be performed in accordance with examples as described herein. In some implementations, aspects of the operations of 902 may be performed by a UE as described with reference to FIG. 6.

At 904, the method may include selecting a time domain offset of the set of time domain offsets based on a UE capability of the set of UE capabilities, where the UE capability corresponds to the UE, and where the time domain offset is between the paging signaling and a RACH occasion of the set of RACH occasions. The operations of 904 may be performed in accordance with examples as described herein. In some implementations, aspects of the operations of 904 may be performed a UE as described with reference to FIG. 6.

At 906, the method may include transmitting, based on the time domain offset, the RACH signaling during the RACH occasion. The operations of 906 may be performed in accordance with examples as described herein. In some implementations, aspects of the operations of 906 may be performed a UE as described with reference to FIG. 6.

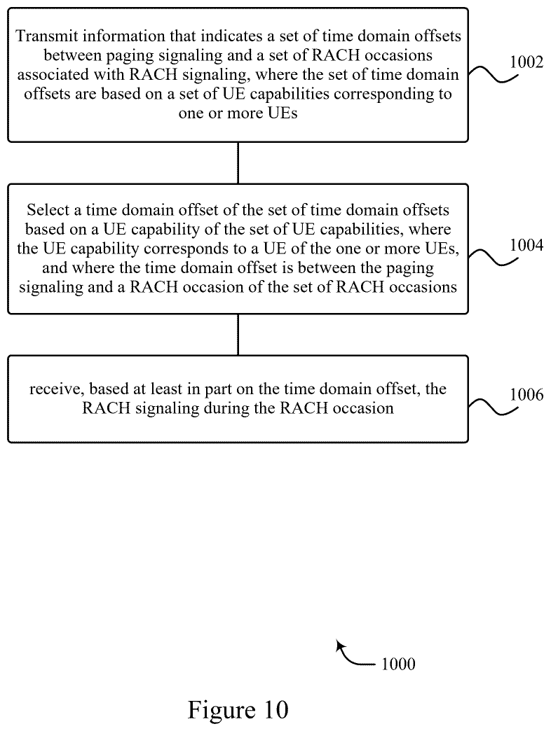

FIG. 10 illustrates a flowchart of a method 1000 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include transmitting information that indicates a set of time domain offsets between paging signaling and a set of RACH occasions associated with RACH signaling, where the set of time domain offsets are based on a set of UE capabilities corresponding to one or more UEs. The operations of 1002 may be performed in accordance with examples as described herein. In some implementations, aspects of the operations of 1002 may be performed by an NE as described with reference to FIG. 8.

At 1004, the method may include selecting a time domain offset of the set of time domain offsets based on a UE capability of the set of UE capabilities, where the UE capability corresponds to a UE of the one or more UEs, and where the time domain offset is between the paging signaling and a RACH occasion of the set of RACH occasions. The operations of 1004 may be performed in accordance with examples as described herein. In some implementations, aspects of the operations of 1004 may be performed an NE as described with reference to FIG. 8.

At 1006, the method may include receiving, based on the time domain offset, the RACH signaling during the RACH occasion. The operations of 1006 may be performed in accordance with examples as described herein. In some implementations, aspects of the operations of 1006 may be performed an NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive information that indicates a plurality of time domain offsets between paging signaling and a plurality of random access channel (RACH) occasions associated with RACH signaling, wherein the plurality of time domain offsets are based at least in part on a set of UE capabilities;
select a time domain offset of the plurality of time domain offsets based at least in part on a UE capability of the set of UE capabilities, wherein the UE capability corresponds to the UE, and wherein the time domain offset is between the paging signaling and a RACH occasion of the plurality of RACH occasions; and
transmit, based at least in part on the time domain offset, the RACH signaling during the RACH occasion.

2. The UE of claim 1, wherein to transmit the RACH signaling, the at least one processor is further operable to cause the UE to:
receive the paging signaling; and
select the RACH occasion based at least in part on the paging signaling and the time domain offset.

3. The UE of claim 1, wherein the at least one processor is further operable to cause the UE to monitor for the paging signaling using at least one of a low power state or a low power radio, wherein the time domain offset comprises an additional time domain offset associated with switching from the low power state or the low power radio to transmit the RACH signaling.

4. The UE of claim 1, wherein the at least one processor is further operable to cause the UE to:
monitor for the paging signaling using at least one of a low power state or a low power radio; and
refrain from applying, based at least in part on the time domain offset, an additional time domain offset associated with switching from the low power state or the low power radio to transmit the RACH signaling.

5. The UE of claim 1, wherein the UE capability is based at least in part on at least one of a device type of the UE or an operation mode of the UE.

6. The UE of claim 1, wherein the information is received in a system information block (SIB), wherein at least one parameter associated with the SIB indicates at least one of the plurality of time domain offsets or a plurality of back-off indicator (BI) values associated with the set of UE capabilities, and wherein the at least one processor is further operable to cause the UE to:
select, based at least in part on a failure to receive a response to the RACH signaling, a BI value of the plurality of BI values, wherein the BI value is associated with the UE capability; and
transmit, after expiry of the BI value, additional RACH signaling during an additional RACH occasion.

7. The UE of claim 1, wherein to receive the information, the at least one processor is operable to cause the UE to receive the paging signaling comprising at least one field that indicates the information.

8. The UE of claim 1, wherein the information is received in a synchronization signal block (SSB) associated with a periodicity, and wherein the paging signaling and the SSB are within a threshold duration based at least in part on the periodicity and based at least in part on an active transmission duration associated with a network equipment (NE).

9. The UE of claim 1, wherein the information comprises a mapping between one or more paging occasions associated with the paging signaling and one or more RACH occasions associated with the RACH signaling, and wherein the time domain offset is based at least in part on the mapping.

10. The UE of claim 1, wherein the at least one processor is further operable to cause the UE to transmit a wake-up signal that indicates a public land mobile network (PLMN), wherein the information is received in response to the wake-up signal and from a network equipment (NE) associated with the PLMN.

11. A method performed by a user equipment (UE), the method comprising:
receiving information that indicates a plurality of time domain offsets between paging signaling and a plurality of random access channel (RACH) occasions associated with RACH signaling, wherein the plurality of time domain offsets are based at least in part on a set of UE capabilities;
selecting a time domain offset of the plurality of time domain offsets based at least in part on a UE capability of the set of UE capabilities, wherein the UE capability corresponds to the UE, and wherein the time domain offset is between the paging signaling and a RACH occasion of the plurality of RACH occasions; and
transmitting, based at least in part on the time domain offset, the RACH signaling during the RACH occasion.

12. A network equipment (NE) for wireless communication, comprising:
at least one memory; and
at least one processor coupled with the at least one memory and operable to cause the NE to:
transmit information that indicates a plurality of time domain offsets between paging signaling and a plurality of random access channel (RACH) occasions associated with RACH signaling, wherein the plurality of time domain offsets are based at least in part on a set of user equipment (UE) capabilities corresponding to one or more UEs;
select a time domain offset of the plurality of time domain offsets based at least in part on a UE capability of the set of UE capabilities, wherein the UE capability corresponds to a UE of the one or more UEs, and wherein the time domain offset is between the paging signaling and a RACH occasion of the plurality of RACH occasions; and
receive, based at least in part on the time domain offset, the RACH signaling during the RACH occasion.

13. The NE of claim 12, wherein to receive the RACH signaling, the at least one processor is further operable to cause the NE to:
transmit the paging signaling; and
select the RACH occasion based at least in part on the paging signaling and the time domain offset.

14. The NE of claim 12, wherein the UE capability is based at least in part on at least one of a device type of the UE or an operation mode of the UE.

15. The NE of claim 12, wherein the information is transmitted in a system information block (SIB), and wherein at least one parameter associated with the SIB indicates at least one of the plurality of time domain offsets or a plurality of back-off indicator (BI) values associated with the set of UE capabilities.

16. The NE of claim 12, wherein to transmit the information, the at least one processor is operable to cause the NE to transmit the paging signaling comprising at least one field that indicates the information.

17. The NE of claim 12, wherein the information is transmitted in a synchronization signal block (SSB) associated with a periodicity, and wherein the paging signaling and the SSB are within a threshold duration based at least in part on the periodicity and based at least in part on an active transmission duration associated with the NE.

18. The NE of claim 12, wherein the information comprises a mapping between one or more paging occasions associated with the paging signaling and one or more RACH occasions associated with the RACH signaling, and wherein the time domain offset is based at least in part on the mapping.

19. The NE of claim 12, wherein the at least one processor is further operable to cause the NE to receive a wake-up signal that indicates a public land mobile network (PLMN), wherein the information is transmitted in response to the wake-up signal and based at least in part on the PLMN being associated with the NE.

20. A method performed by a network equipment (NE), the method comprising:
transmitting information that indicates a plurality of time domain offsets between paging signaling and a plurality of random access channel (RACH) occasions associated with RACH signaling, wherein the plurality of time domain offsets are based at least in part on a set of user equipment (UE) capabilities corresponding to one or more UEs;
selecting a time domain offset of the plurality of time domain offsets based at least in part on a UE capability of the set of UE capabilities, wherein the UE capability corresponds to a UE of the one or more UEs, and wherein the time domain offset is between the paging signaling and a RACH occasion of the plurality of RACH occasions; and
receiving, based at least in part on the time domain offset, the RACH signaling during the RACH occasion.
